(19) United States
(12) Patent Application Publication
(10) Pub. No.: US 2006/0103668 A1
(43) Pub. Date: May 18, 2006

(54) Dynamic representation process and system for a space of characterized objects enabling recommendation of the objects or their characteristics

(75) Inventors: Emmanuel Spinat, Paris (FR); Franck Lugue, Paris (FR); Franck Valetas, Paris (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Voyez Vous, a corporation of France, Paris (FR)

(21) Appl. No.: 11/320,125

(22) Filed: Dec. 28, 2005

Related U.S. Application Data
(63) Continuation of application No. 10/449,637, filed on May 30, 2003.
Application No. 10/449,637 is a continuation of application No. PCT/FR01/03798, filed on Nov. 30, 2001.

(30) Foreign Application Priority Data
Dec. 1, 2000 (FR) 00/15599
Dec. 13, 2000 (FR) 00/16241

(51) Int. Cl. G09G 5/00

(52) U.S. Cl. 345/619

(57) ABSTRACT

A process for generating a dynamic and contextualized cartography of information including a step of collaborative filtration which includes determining at least one affinity group formed from a set of profiles, wherein the distance from the profile to a reference object is less than a threshold value, a step of correlation analysis of characteristics of the reference object and objects of the affinity group projecting the characteristics into a multidimensional space, and a step of construction of an image composed of activatable zones representing the characteristics of the reference object and of all or part of the characteristics of the affinity group, and zones representing links among the characteristics, each zone providing direct or indirect access to one or more digital files.

### RELATED APPLICATION

This is a continuation of International Application No. PCT/FR01/03798, with an international filing date of Nov. 30, 2001, which is based on French Patent Application No. 00/15599, filed Dec. 1, 2000, and French Patent Application No. 00/16241, filed Dec. 13, 2000.

### FIELD OF THE INVENTION

This invention pertains to the field of the dynamic representation of information to facilitate organization of informational objects as a function of their categorial relationships (characteristics) to enable rapid access to objects in this space and to implement recommendations of the objects or their characteristics.

### BACKGROUND

The considerable increase in the amount of information accessible especially online via the Internet or in private information systems makes it difficult to provide the user with rapid access to pertinent information.

It has, therefore, been perceived as necessary during recent years to provide the user with a visual synthesis of this information space based on an analysis of the correlations existing among the information units. The user can employ such cartographic tools to orient himself in a multidimensional representation of the information system to more rapidly reach the information of interest.

Various information cartography solutions are known in the state of the art. For example, WO 95/04960 pertains to a computer-based program for managing information extracted from a structured database such as a relational database. The processor constructs a multiplicity of object instances each of which has its own unique object identification map which produces a cartography between the object instance and at least one row of the structured database. The processor constructs a single structure of cohesive data, called an “object ante-memory”, which contains all of the object instances and represents the information retrieved from the structured database in a form suitable for use by one or more object-oriented programs.

WO 95/06292 pertains to a computerized tool for modeling database conceptions and the specification of the interrogations of the data that they contain in the form of a fact tree. An interrogation cartography is used to generate interrogations once the fact tree has been verified.

WO 98/40832 pertains to a process used for recommending articles to users by means of profiles of users of automated cooperative stores which are processed like articles stored in a memory. Profiles of articles can also be stored in the memory, the article profiles associating the users with a rating that a user attributes to the article, or with a rating that the system attributes by deduction to the user. The user profiles comprise supplementary information concerning the user or information associated with the rating attributed by the user to an article. User profiles are retrieved and the ratings used for calculating similitude factors with other users. The similitude factors, sometimes linked to confidence factors, are used for selecting a set of neighboring values. The neighboring values are weighted according to their respective similitude factors to obtain a rating prediction for an article that is part of the domain under consideration.

An object serving to provide a storage of hierarchical isolated data can be used in an article recommendation process for a given user. The data object is associated with an element of physical memory and provides an interface for storing and retrieving data from the physical memory element. A system enabling activation of an information market comprises a central server storing data in a memory element. The data can be encrypted or not encrypted. In either case, the server can also store a table associating data elements and nodes with an authorization value. If a node requests data for which the authorization value of the table grants access, the server transmits the data to the node. If the data are encrypted, the server can transmit the encrypted data or decrypt the encrypted data for the node before transmitting them.

It would, therefore, be advantageous to provide improved tools and processes of information cartography by enabling a new mode of visual organization of the means of information localization and referencing.

### SUMMARY OF THE INVENTION

The invention relates to a process for generating a dynamic and contextualized cartography of information including a step of collaborative filtration which includes determining at least one affinity group formed from a set of profiles, wherein the distance from the profile to a reference object is less than a threshold value, a step of correlation analysis of characteristics of the reference object and objects of the affinity group projecting the characteristics into a multidimensional space, and a step of construction of an image composed of activatable zones representing the characteristics of the reference object and of all or part of the characteristics of the affinity group, and zones representing links among the characteristics, each zone providing direct or indirect access to one or more digital files.

### BRIEF DESCRIPTION OF THE DRAWINGS

FIG. 1 is a schematic diagram illustrating an example of preplacement of the base characteristics during the correlation analysis.

FIG. 2 is a schematic diagram illustrating an example of preplacement of the characteristics (other than the base characteristics) during the correlation analysis.

FIG. 3 is a diagram illustrating an example of the system interface using the analogy of the “neighborhood map” in the domain of auction Web sites, with examples of menus.

FIG. 4 is a diagram illustrating an example of the system interface using the analogy of the “neighborhood map” applied to the domain of online commerce Web sites.

FIG. 5 is a schematic diagram illustrating an example of the system interface using the “store layout” analogy applied to the domain of online commerce Web sites.

FIG. 6 is a schematic diagram of the functional architecture of a subset of the system called “precalculation server”.

FIG. 7 is a schematic diagram of the functional architecture of a subset of the system called “map server”.

### DETAILED DESCRIPTION

For a Web site in particular, the user is provided with a synthesized and personalized vision of that which the user has already done (histories), where the user is situated in relation to other users and the user's own characteristics and where the user can go (prospects of products/services). Thus, the representation becomes a means for navigation on the site.

According to its most general sense, the invention pertains to a process for the generation of a dynamic cartography of an information space composed of objects described in the form of elementary descriptors called “characteristics”. Each object and characteristic can be associated with addresses of digital files.

This involves constructing for a user a synthesized vision of objects and their characteristics in the form of a multidimensional representation called a “map”. This map is generated by an analysis of the correlations among the characterized objects.

The map makes it possible to more rapidly reach the objects or characteristics likely to interest the user and make recommendations of the objects or characteristics. The map can be personalized by taking into account the specificities of the user.

The map is constituted by a set of activatable zones capable of accessing the represented objects, or the characteristics or other information pertaining to them such as recommendations. This access can be performed directly or by the intermediary of a menu.

The process more generally comprises sorting and filtering characterized objects and then constructing an image enabling access to the descriptions of the objects and their characteristics via activatable zones positioned as a function of the degree of correlation between the characteristics of the objects, characterized in that it comprises:

a first step of evaluation of the profile of each object by means of its characteristics (the profile being a description of the set of characteristics of the object),

a second step of collaborative filtration including determining at least one affinity group constituted by the set of profiles the distance of which in relation to a given profile is less than a threshold value,

a third step of correlation analysis of the characteristics of the objects of the affinity group projecting the characteristics into a multidimensional space, and

a fourth step of construction of an image composed of activatable zones representing the characteristics of the affinity groups, activatable zones representing the affinity group objects and the zones representing the links among the characteristics, each zone providing direct or indirect access to one or more digital files. During this step, recommendations of characteristics or subcharacteristics can be calculated for a given zone in relation to a particular object which is then referred to as “reference object”.

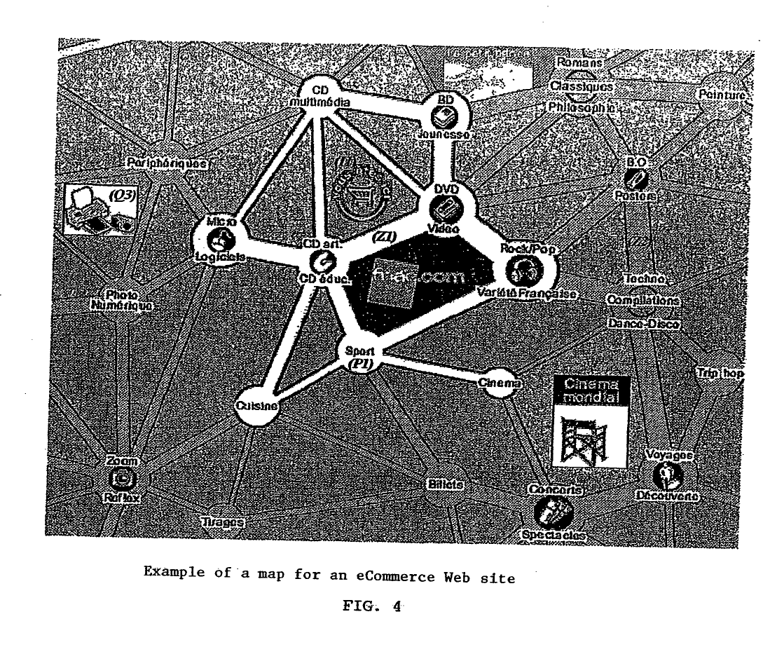

One implementation of the fourth step consists of using the analogy of a “neighborhood map”, describing the characteristics in the form of “squares”, the zones representing the objects by “neighborhoods”, the zones representing the links among characteristics by “streets”. FIG. 4 illustrates an example of this type of implementation.

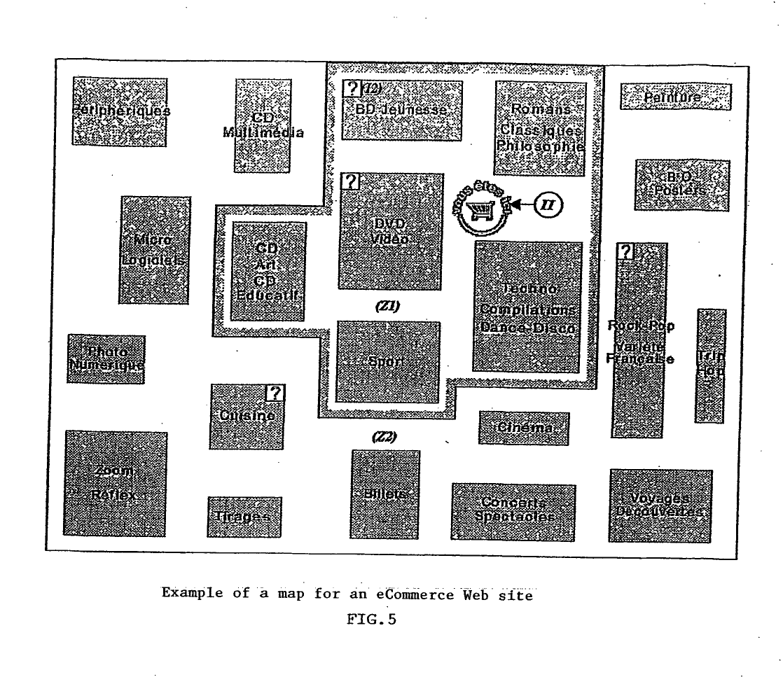

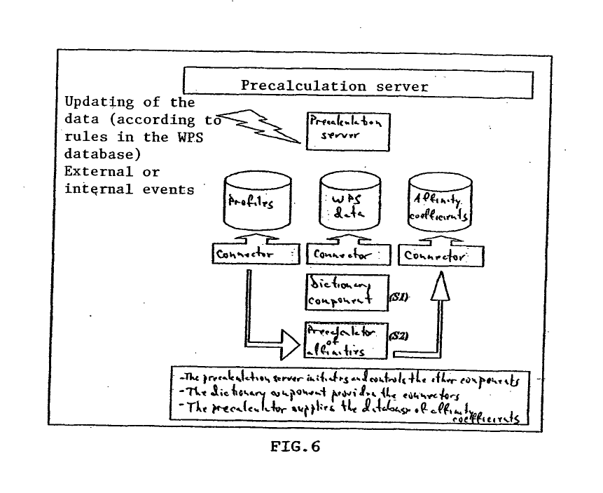

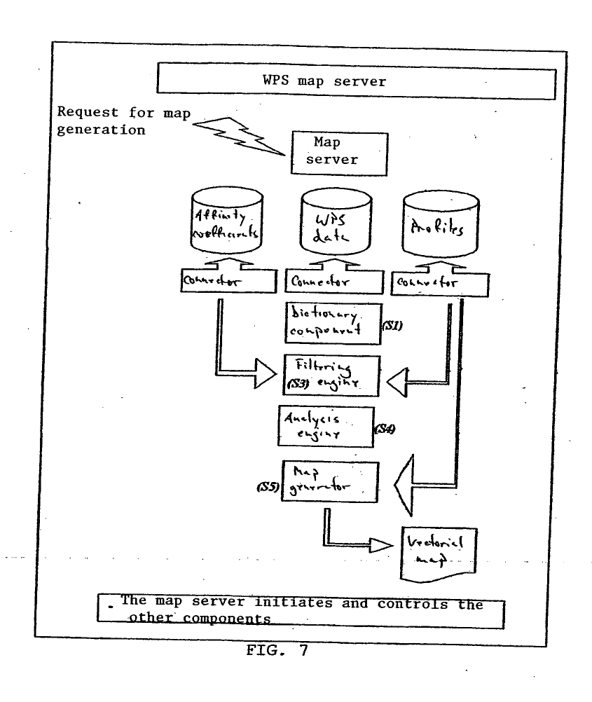

One implementation of the fourth step includes using the analogy of the “store layout” map describing the zones representing the characteristics in the form of “departments”, the zones representing the links among characteristics by the “aisles” between the departments, the zones representing the objects by polygons in the “aisles”. FIG. 5 illustrates an example of this type of implementation.

The process preferably includes a step of calculating the implicit characteristics of a user, consisting of recording in a memory the parameters associated with descriptions of historical actions of said user. The descriptors of the historical actions of the user can be constituted notably by the identifiers of the pages consulted by the user.

According to a variant, the process according to the invention includes a step of calculating the explicit characteristics of a user, consisting of recording in a memory the parameters defined from a preferences table. These characteristics used for data analysis can be visible or not visible on the graphical representation.

A better understanding of the invention will be obtained from the description below with reference to the attached figures in relation to a nonlimitative example of implementation.

This description comprises a first part related to the methods for the calculation of the components employed by the invention, a second part describing several examples of interfaces and a third part presenting an example of functional decomposition of a system for the implementation of the invention.

The process according to aspects of the invention is based on the characterization of objects by characteristics and subcharacteristics. An “object” is an element of a set of objects that can be differentiated by elemental information describing them and called “characteristics”. It can be applied to a user, a site or any other form of information. The objects and the characteristics can be positioned on the graphical representation referred to as a “map”.

The map can be calculated according to the characteristics of a reference object to personalize it (i.e., to take into account the point of view of the object).

As an example, for the cartography of the information contained in a Web auction site:

the objects are the users (internauts),

the reference object is the “current” user (connected to the site),

the characteristics are the headings defined by the site,

the subcharacteristics correspond to the auctions in progress,

the user profile is, thus, composed of implicit characteristics deduced from the transaction history (headings where the user implemented sales and purchases or auctions) and the navigation history (headings consulted by the user).

The following definitions are established:

the set of objects O={o₀, o₁, . . . oₖ, . . . Oₘ₋₁}, m=Card(O),

the set of the characteristics C={c₀, cₗ, . . . cᵢ, . . . cₙ₋₁} describing the objects, n=Card(C), and

the set of the subcharacteristics C′=(c′₀, c′₁, . . . c′ᵢ . . . c′_{P-1}} describing the objects, p=Card (C′).

For each characteristic cᵢεC′ there is defined a set of associated subcharacteristics noted as C′ⱼ such that C′ᵢ⊂C′. We should note that C′=∪C′ᵢ (i.e., the C′ᵢ form a partition of C′).

The profiles are then defined, formed by a set of characteristics that can be weighted. These characteristics can be heterogeneous. Multiple profiles can be defined for the same object.

The matrix of the noted profiles is defined as
P=P_{m,n}(R)=(p_{k,i})
in which p_{k,i} is a weighting describing the value of the characteristic cᵢ for the object oₖ.

Each object oₖ is, thus, described by a vector (p′_{k,0}, . . . , p′_{k,i} . . . , p′_{k,p-1}).

We defined the matrix P′=P′_{m,p}(R)=(p′_{k,i}) in which p′_{k,i} is a weighting describing the value of the subcharacteristic c′ᵢ for the object oₖ.

Each object oₖ is, thus, described by a vector (p_{k,0}, . . . , p_{k,i} . . . , p_{k,n-1}).

We defined:

the set of characteristics linked to an object Ok written as C(oₖ)={cᵢεC/p_{k,i}≠}

the set of subcharacteristics linked to an object Ok written as C′(oₖ)={c′ᵢεC′/p_{k,i}≠0}

the set of objects linked to a characteristic cᵢ written as O(cᵢ)={oₖεO/p_{k,i}≠0}

the set of objects linked to a subcharacteristic c′ᵢ written as O(c′ᵢ)={oₖεO/p′_{k,i}≠0}

Ray Tracing

We defined R ray tracing matrix/R_{n,n}(N)=(r_{i,j}).

This matrix expresses the links created by the objects between the characteristics.

$$\begin{matrix}{r}_{i , j} = ray tracing between two characteristics {c}_{i} and {c}_{j} \\ = Card ( O ( {c}_{i} ) ⋂ O ( {c}_{j} ) ) \\ = number of objects common to two chracteristics .\end{matrix}$$

We are thus dealing with a symmetrical matrix, i.e., r_{i,j}=r_{j,i}.

r_{i,i} is the number of objects oₖ in which p_{k,i}≠0, i.e., the number of objects having cᵢ as a characteristic. This is the frequency of the characteristic cᵢ, written as fᵢ.

By extension we define:

the vector of ray tracing of a characteristic i: rᵢ=(r_{i,0}, r_{i,1}, . . . r_{i,j}, . . . r_{i,n-1}):

the set of ray tracing of a characteristic=Rᵢ={cⱼεC/r_{i,j}≠0}, i.e., the set of characteristics having at least common object with the characteristic cᵢ.

the set of ray tracing of a set A of characteristics written

$${R}_{A} = {⋃}_{l / {c}_{i} ∈ A} {R}_{I}$$

We define:

the vector of ray tracing of a set A⊂C: r_{A}/(r_{A})ₙ(N)=r_{A,j}

in which

$${R}_{A , j} - Card ( ( {⋃}_{l / {c}_{i} ∈ A} O ( {c}_{i} ) ) ⋂ O ( {c}_{j} ) )$$

the Power of ray tracing of a characteristic=Prᵢ=

$${\sum }_{j / {c}_{j} ∈ C} {r}_{i , j} = {\sum }_{k / {o}_{r} ∈ o ( {c}_{i} )} Card ( C ( {o}_{k} ) )$$

Weighted Ray Tracing

Simple ray tracing does not necessarily allow for expression of the force of the link between two characteristics in its context (i.e., all of the objects). Thus, for example: a characteristic cᵢ having a single object common with cᵢ would give us r_{i,j}=1 no matter the frequency of cᵢ and cⱼ (1 occurrence or 1000!). The importance of the resultant link is nevertheless different.

This is why we define the exclusive weighted ray tracing between two characteristics cᵢ and cⱼ to evaluate the importance of the link between characteristics.

$$\begin{matrix}{rp}_{i , j} = weighted ray tracing between charactersitics {c}_{i} and {c}_{j} \\ = \frac{{r}_{i , j}}{min ( {f}_{i} , {f}_{j} )}\end{matrix}$$

Note that rp_{i,j}≦1.

This coefficient expresses the power of the link between cᵢ and cⱼ in the form of a coefficient comprised between 0 and 1. If rp_{i,j}=1, then (Rᵢ−Rⱼ) or (Rⱼ−Rᵢ)=Ø, i.e., when the characteristic cᵢ is in an object, cⱼ is also in this object or when the characteristic cⱼ=in an object, cᵢ is also in this object.

By extension, we thus define:

the weighted ray tracing between a characteristic cᵢ and a set A of characteristic written

$${rp}_{i , A} = \frac{{r}_{i , A}}{min ( {f}_{A} , {f}_{j} )}$$

in which

$${f}_{A} = \frac{max}{j / {c}_{j} ⋐ C} ( {f}_{j} )$$

the weighted Power of ray tracing of a characteristic

$${c}_{i} = {Prp}_{i} = {\sum }_{j / {c}_{j} ∈ C} {rp}_{i , j}$$

Exclusive Weighted Ray Tracing

We needed a coefficient enabling measurement of the importance of that which differentiates the ray tracing of two characteristics to construct a base of characteristics (i.e., a set of characteristics allowing expression of other characteristics). This coefficient provides assurance that the differentiation results from the two characteristics. The symmetrical difference between Rᵢ and Rⱼ (written RᵢΔRⱼ) is, thus, not sufficient because, despite a strong symmetrical difference, it is still possible to have Rᵢ−Rⱼ or Rⱼ−Rᵢ=Ø.

This is why we define RP₍ₑₓ₎ exclusive weighted ray tracing matrix/RP_{(ex)n,n}(N):=(rp_{(ex)i,j})

rp_{(ex)i,j}=exclusive weighted ray tracing between two characteristics cᵢ and cⱼ

rp_{(ex)i,j}=

=common level of differentiation between two characteristics cᵢ and cⱼ.

This is, therefore, a symmetrical matrix, i.e., rp_{(ex)i,j}=rp_{(ex)j,i}

By definition, we define the exclusive weighted ray tracing between a set A⊂C and a characteristic cᵢ

rp_{(ex)i,A}=

We defined the exclusive weighted ray tracing Power of a characteristic

$${c}_{i} = {Prp}_{( ex ) i} = {\sum }_{j / {c}_{j} ∈ C} {rp}_{( ex ) i , j}$$

1. Filtering and Recommendation
Coefficient of Affinity

This involves expressing a distance between two objects as a function of their respective profile. This value makes it possible both to define the affinity group of an object oₖ to limit the analysis to these objects and also to assist in the calculation of recommendation.

This distance takes into account both the intersection, but also the symmetrical difference between the two profiles. Two objects having the same intersection, but a divergent symmetrical difference, would not be considered to be similar.

Thus, we define the coefficient of affinity between two objects oₖ and oᵢ, written A_{i,j} such that

wherein Maxₚ is the maximal value of p_{k,i} and

ψ is a function defining the importance of the weightings in the coefficient of affinity.

By default, we set ψ(p,Maxₚ)=log_{Maxp}(p+1) which minimizes the effect of the weighting.

We define the affinity group of an object oₖ written Affₖ such that

Affₖ={o₁εO/A_{k,1}≧Aₘᵢₙ} in which Aₘᵢₙ is a threshold set by the WPS manager.

Coefficient of Recommendation

We define the coefficient of recommendation of a characteristic cᵢ for an object oₖ. This coefficient indicates the level of recommendation: the higher the coefficient, the more pertinent is the recommendation; the smaller the coefficient, the more it is subject to caution.

If p_{k,i}≠0, then Recᵢ=, if not then Recᵢ=0

wherein ψ is the function as defined above.

We define the coefficient of recommendation of a subcharacteristic c′ᵢ for an object oₖ.

If p′_{k,i}≠0, then Rec′ᵢ=, if not then Rec′ᵢ=0.

2. Analysis

Ray Tracing Family of Base Ro

The base family is a set of characteristics that will be used as a base for expressing the positioning of the other characteristics on the map.

Reference Object

When there exists a reference object Oᵣ then Pᵣ⊂Ro.

1. We write R′o, the set Ro in the process of constitution (calculation) and we, therefore, initially set R′o=Pᵣ

2. Then we add to the set R′o, the characteristics ci having rp_{(ex)R′o,i} maximal, i.e., R′o=R′o+{cᵢεC/cᵢ∉R′o & rp_{(ex)R′o,i} maximal} until the ray tracing set ((R_{R′o}=C) & (Card(R′o)>=3))

3. Then Ro=R′o.

Optimal Base

In the case of absence of a reference object, WPS calculates an “optimal” base for expressing the positioning of the characteristics.

1. R′o is constituted initially by the characteristic cᵢ having the highest Prpᵢ,

2. Then we add to the set R′o, the characteristics ci having rp_{(ex)R′o,i} maximal, i.e., R′o=R′o+{cᵢεC/cᵢ∉R′o & rp_{(ex)R′o,i} maximal} until the ray tracing set ((R_{R′o}=C) & (Card(R′o)>=3))

3. Then Ro=R′o.

Placement of the Base Ro

We note EC(A) the convex envelope formed by a set A of points.

We note R′o, the set of characteristics already placed, initially R′o=Ø

Calculation of O′_{ref}

If a reference object exists, we calculate at each iteration the reference point O′_{ref} such that

$${\sum }_{j / {c}_{j} ∈ {R}^{′} o} {p}_{ref , l} ( \overline{{C}_{j} {O}_{ref}} ) = \overline{0}$$

$$If not {\sum }_{j / {c}_{j} ∈ {R}^{′} o} ( \overline{{C}_{j} {O}_{ref}^{′}} ) = \overline{0}$$

We place in the center, the characteristic cᵢ of the base having the highest Prpᵢ.

Then we place the characteristics cᵢ having rp_{(ex)R′O,i} maximal, i.e., R′o=R′o+{cᵢεC/c_{iε}∉R′o & rp_{(exp)R′o,i} maximal.

1. if ∃cⱼεR′o/rp_{(ex)i,j}=0, then Cᵢ=Cⱼ

2. ∀cⱼεR′o, |CᵢCⱼ|>=rp_{(ex)i,j}

3. Cᵢ∉EC(R′o),

4. |CᵢO′_{ref}| is minimal.

Placement of the object O_{ref}

Stemming from the placement of the base Ro, we place the reference object O_{ref} such that

$${\sum }_{j / {c}_{j} ∈ {R}^{′} o} {p}_{ref , j} ( \overline{{C}_{j} {O}_{ref}} ) = \overline{0}$$

In the case of a lack of reference object, one takes into consideration a “virtual” reference object such that

$${\sum }_{j / {c}_{j} ∈ {R}^{′} o} ( \overline{{C}_{j} {O}_{ref}} ) = \overline{0}$$

FIG. 1 shows an example of placement of a new characteristic Cᵢ of Ro. R_{0,0}, R_{0,1}, and R_{0,2} represent three characteristics of Ro already placed on the map. The circle enclosing them represents the minimal distance defined in rule 2 (above). O′_{ref} represents the reference point such that

$${\sum }_{j / {c}_{j} ∈ {R}^{′} o} {p}_{ref , j} ( \overline{{C}_{j} {O}_{ref}^{′}} ) = \overline{0} ,$$

taking into account the three points that have already been placed (R_{0,0}, R_{0,1} and R_{0,2}). The triangle bringing together the points (R_{0,0}, R_{0,1} and R_{0,2}) represents the convex envelope of R′o, written as EC(R′o). The placement of Cᵢ, written as R_{0,3}, is obtained by determining the closest point of O′^{ref} and not being included in the convex envelope nor either the area formed by the three circles.
Placement of the Characteristics

We define cᵢ the point corresponding to the characteristic cᵢ. We place the characteristics as a function of their links with the base elements Ro.

We note R′, the set of previously placed characteristics

Initially R′=Ø

We choose the characteristics cᵢ in decreasing order of r_{Ro,1}

i.e., R′=R′+{cᵢεC/cᵢ∉R′ & r_{Ro,i} maximal}

The placement of Cᵢ is then defined according to the following rules:

1. if ∃cⱼεRo/rp_{i,j}=1, then Cᵢ=Cⱼ

2. if ∃cⱼε(R′-Ro)/rp_{i,j}=1-ε, then Cᵢ=Cⱼ

3. ∀cⱼRo & rp_{i,j}≠0, |CᵢCⱼ|>=(1/rp_{i,j})−1

4. cᵢ⊂/EC(Ro)

5. |CᵢO_{ref}| or minimal.

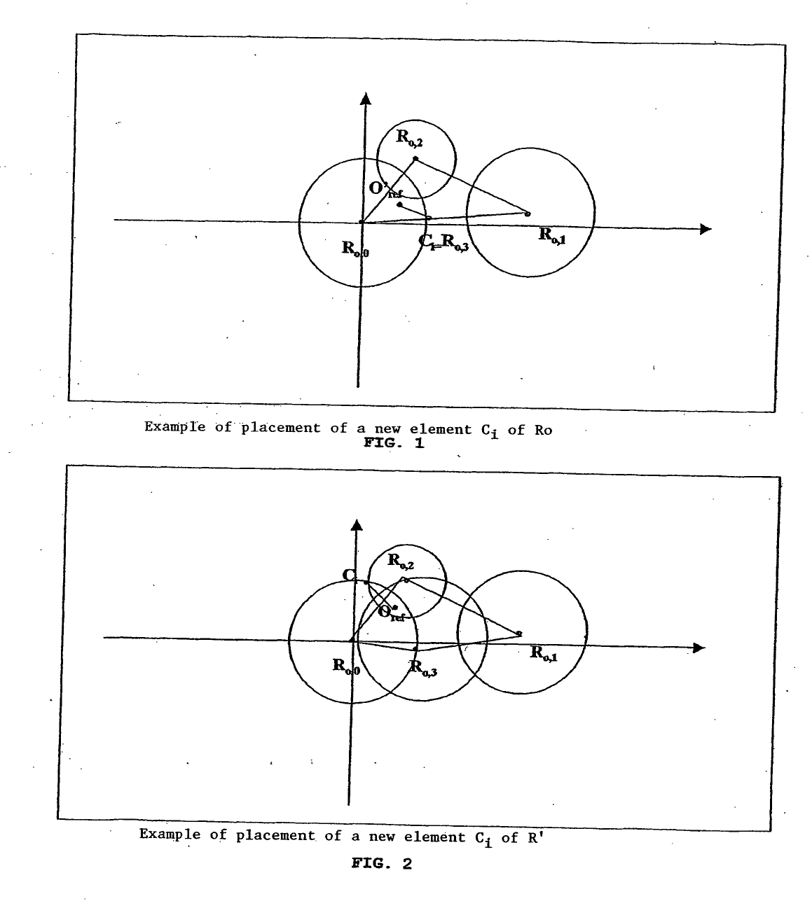

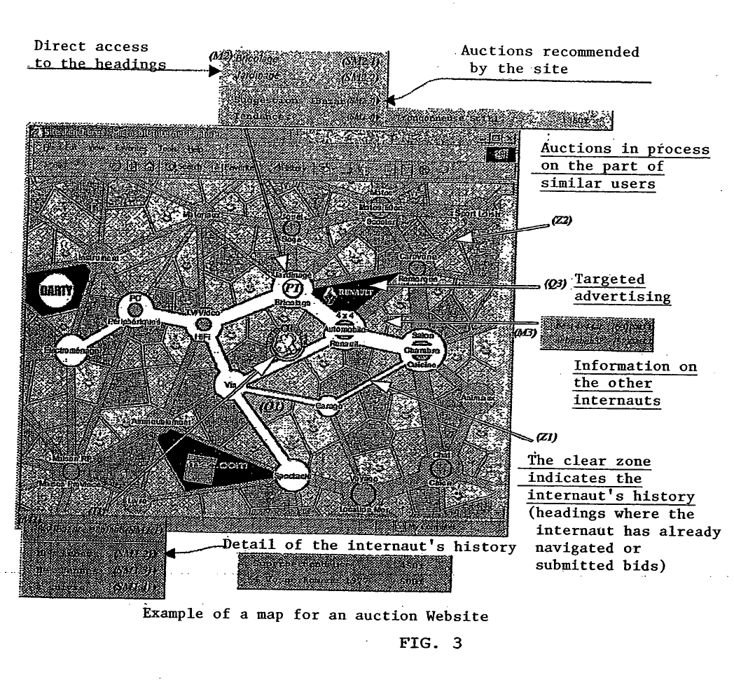

FIG. 2 shows an example of placement of a new characteristic Cᵢ of {C-Ro}. R_{0,0}, R_{0,1}, R_{0,2} and R_{0,3} represent three characteristics of the base Ro already placed on the map. The circle surrounding them represents the minimal distance in rule 3 presented above. O′_{ref} represents the reference point such that

$${\sum }_{j / {c}_{1} ∈ {R}^{′} o} {p}_{ref , 1} ( \overline{{C}_{j} {O}^{′} ref} ) = \overline{0}$$

taking into account the already placed points (R_{0,0}, R_{0,1}, R_{0,2} and R_{0,3}). The polygon grouping together the points (R_{0,0}, R_{0,1}, R_{0,2} and R_{0,3}) represents the convex envelope of Ro, written EC(Ro). The placement of cᵢ is obtained by determining the closest point of O_{ref} not included in the convex envelope nor in the area formed by the four circles.

The map is constituted by a set of graphical elements to be displayed: squares, neighborhoods and streets in our example of application. These objects can constitute interactive zones that can display menus and submenus.

Squares

Each square represents a set of characteristics. Each point cᵢ represents the positioning of the characteristic c₁. Certain characteristics have identical positions: cᵢ=cⱼ.

The positioning of the squares is performed by a relaxation algorithm among the points P1, each point being linked by a force

We define that the ray of a square is determined by the ray tracing power of the set of characteristics composing it:
L_{(P1b)}=Pr_{c(P1b)}
Streets

Streets connect the squares that are closest to each other. The characteristics of a street are defined by the ray tracing between the squares that it joins (P1_{b} and P1_{c}). The streets, thus, represent the importance of the links uniting two squares, i.e., two sets of characteristics.

$$Width = {W}_{Plb , Plc} = {\sum }_{i / {c}_{i} ∈ {Pl}_{b}} {\sum }_{j / {c}_{j} ∈ {Pl}_{c}} ( {r}_{i , j} )$$

If W_{P1a,P1b}≦ε′ then there is no street.

Placement of the Objects

We define Oₖ as the point corresponding to the object oₖ. Oₖ is placed according to a barycentric principle:

$${\sum }_{j / {c}_{j} ∈ C} {p}_{k , j} ( \overline{{O}_{k} {C}_{j}} ) = \overline{O}$$

in which Cⱼ is the definitive position of the characteristic cᵢ stemming from the positioning of the squares.
Neighborhoods

Each neighborhood Qₐ is composed of a set of objects. Neighborhoods are defined by determining the sets of objects Q such that ∀oₖεQ ∀o₁εQ, |oₖo₁|≦δ in which δ is a distance dependent on the characteristics of the map display device.

After having defined the objects constituting the neighborhoods, we use—for defining the positioning of the neighborhoods—a relaxation algorithm weighted by the surface area of the neighborhoods Qa such that

$${S}_{Qa} = {\sum }_{k / {o}_{a} ⋐ {Q}_{a}} {\sum }_{j / {c}_{j} ∈ C} ( {p}_{k , i} {Pr}_{j} ) .$$

The delimitation of the neighborhoods is then defined by a Voronoi diagram.
Calculation of the Recommendations by Square

We define the coefficient of recommendation of a characteristic cᵢ for an object oₖ. This coefficient indicates the level of recommendation: the larger the coefficient, the more pertinent is the recommendation; the smaller the coefficient, the more it is subject to caution.

If p_{k,i}≠0, then Recᵢ=if not Recᵢ=0.

By default, we set ψ(p,Maxₚ)=log_{Maxp}(p+1) which minimizes the effect of the weighting.

We define the coefficient of recommendation of a subcharacteristic c′ᵢ for an object oₖ.

If p′_{k,i}≠0, then Rec′ᵢ=if not Rec′ᵢ=0.

For each square P1_{b}, we calculate the set of recommended characteristics written as C_{(rec)b}:
C_{(rec)b}={CⱼεP1_{b}/Recⱼ>Rec_{Min}}

We classify the set in decreasing order of the Recⱼ or recommendations of the subcharacteristics:
C′_{(rec)b}={c′ⱼεC′i & cᵢεP1_{b}/Rec′ⱼ>Rec_{Min}}

We classify the set in decreasing order of the Rec′ⱼ, in which Recₘᵢₙ is a threshold set by the WPS manager.

Description of Interfaces

FIGS. 3, 4 and 5 illustrate examples of interfaces that can be derived from the previously presented methods of calculation.

FIG. 3 illustrates an example of an interface of the system using the “neighborhood map” analogy in the domain of auction Web sites with examples of menus and submenus.

The objects correspond to the users of the site (i.e., internauts), the reference object is the current user, the characteristics displayed represent the site headings and the subcharacteristics correspond to the base actions of the user: purchases, sales or bids. The clear zone (21) is constituted by a set of squares representing the profile of the user, i.e., the headings where he has already entered bids.

The icon (II) represents the position of the user on the maps in relation to the weightings applied to the characteristics of his profile. By activating the zone (II), the internaut causes the display of the menu (M1) describing the details of the internaut's profile. Activation of the element (SM1.1) of the menu (M1) gives the internaut access to the Web page describing the current user on the site and provides the internaut with personalized services. The elements of the submenus (SM1.2 and SM1.3) provide access to pages describing the bids associated with the internaut's profile.

The dark zone (Z2) represents headings suggested by the process from analysis of the internaut's affinity group.

Activation of a square (P1) causes display of a menu (M2) comprising choices (SM2.1, SM2.2) which can be activated to directly access the headings, a choice (SM2.3) to obtain product recommendations based on the analysis of the profiles of the users in the affinity group and a choice (SM2.4) to obtain targeted recommendations implemented by the site. The submenu elements (SM2.3) and (SM2.4) can be activated to gain access to the pages describing the recommended objects.

The neighborhoods such as the neighborhood (Q1) represent a set of users as a function of their profiles. Activation of a neighborhood (Q1) causes the display of a menu (M3) containing as elements the aliases of the users of this neighborhood. The activation of an element (SM3.1) of this menu enables access to the Web pages describing each of these users.

The zone (Q3) represents a targeted advertisement defined by the site administrator and the profile of which conforms to that of the user.

FIG. 4 illustrates an example of interface of the system using the analogy of “neighborhood map” applied to the domain of online commerce Web sites.

The objects correspond to the users of the site (i.e., the internauts), the reference object is the current user, the displayed characteristics represent the site headings and the subcharacteristics correspond to the products purchased by the users. The clear zone (Z1) is constituted by a set of squares representing the profile of the user, i.e., the headings where he has already implemented purchases (or possibly navigated).

The icon (I1) represents the position of the user on the map with relation to the weightings applied to the headings of his profile. By activating the zone (I1), the internaut causes the display of a menu describing the detail of the internaut's profile and providing the internaut with to access the pages describing the products associated with the nternaut's profile.

The dark zone (Z2) represents the headings suggested by the process from the analysis of the profiles of the internaut's affinity group.

The square (P1) represents a set of headings remaining to be discovered by the internaut. Activation of the square (P1) causes display of a menu making it possible to obtain notably product recommendations based on the analysis of the profiles of the affinity group users or targeted recommendations implemented by the site. The site can add specific menus such as, for example, the best sales of the headings represented by this square.

The zone (Q3) represents the advertising of a product, targeted and defined by the site administrator and the profile of which conforms to that of the user. Activation of this advertisement cause display of the page describing this advertisement, a page which possibly resides on another site.

FIG. 5 illustrates an example of interface of the system using the analogy of “store layout” map applied to the domain of online commerce Web sites.

The objects correspond to the users of the site (i.e., internauts), the reference object is the current user, the displayed characteristics represent the site headings and the subcharacteristics correspond to the products purchased by the users. The clear zone (Z1) is constituted by a set of departments representing the user's profile, i.e., the headings where the user already implemented purchases (or possibly navigated).

The icon (I1) represents the position of the user on the map in relation to the weightings applied to the headings of the user's profile. By activating the zone (I1), the internaut causes the display of a menu describing the details of the user's profile and allows access the pages describing the products associated with the user's profile.

The dark zone (Z2) represents the headings suggested by the process from the analysis of the profiles of the internaut's affinity group.

The department (P1) represents a set of headings remaining to be discovered by the internaut. Activation of the department (P1) causes the display of a menu making available notably product recommendations based on the analysis of the profiles of the users of the affinity group or the targeted recommendations implemented by the site. The site can add specific menus such as, for example, the best sales of the headings represented by this location.

The icon (I2) (in the form of a question mark) represents the advertising of a product, targeted and defined by the site administrator and the profile of which confirms to that of the user. Activation of this advertisement causes the display of an image representing the advertisement and also provides access to the Web page describing this advertisement, a page which possibly resides on another site.

These three previously described interfaces can be applied to other types of Web sites such as, for example, recruitment sites, community sites, online brokerage sites or online banking sites.

Functional Description

We provide details below regarding the functional architecture of a system for the implementation of the invention.

The system can be broken into two server subsystems which are independent in their operations: the precalculation server (FIG. 1) and the map server (FIG. 2). This system is completed by a client component called the “map displayer” and a set of administration tools.

The manager (S1) of WPS data is a server component also referred to as a “dictionary component”.

It uses as input data: user identifier, map name, identifier of objects. In response it provides information on or descriptions of the objects.

This is the component which makes the link between the physical data (BD) and the WPS logical data which will be used by the other WPS components.

This access component must be sufficiently open to confront the various solutions found in practice. For this purpose, connectors enable links between the WPS data model and the external platforms. Standard connectors are provided (such as a generic -ODBC or JDBC-access and native Oracle initially), but also openings with API (C++, Java) or XML. Specific connectors can be developed for the most widely available content management platforms.

The proposed system requires the installation of a WPS database for storing the specific data such as:

Precalculation data on the affinity among the profiles,

Data on advertisements and recommendations.

The multiplicity of sources of data (and, thus, of the descriptions of profiles) and the heterogeneous nature of the characteristics of the profiles impose a very flexible data model. The definition of a data meta-model and the creation of a meta-model dictionary are indispensable elements for the adaptation of this technology to the different application domains (in particular, the implementation of connectors).

The WPS dictionary contains for each map the data model of the map and the information for accessing the data describing the characteristics, user profile, advertising and recommendations. It does not contain the data themselves which are stored either in the WPS database or in an external database.

The affinity precalculator (S2) is a server component that accesses the data describing the profiles and stores the coefficient of affinity between each pair of profiles.

This component is implemented to avoid a bottleneck on the filtering time in the form of a background server processor which precalculates on a permanent basis the coefficients of affinities between the profiles.

From the user identifier, the server system can read the characteristics of the user profile. This module enables determination of the affinity group (the close profiles) to limit the volume of data that is processed in the next step.

This first filtering is principally based on:

possibly specific criteria of membership in a given group (for example, sociodemographic criteria: membership in the same age classification, the same geographic situation or the same socioprofessional category),

the coefficient of affinity between two profiles,

an affinity threshold below which the affinity between profiles is considered to be zero.

It is this affinity coefficient that will be stored in the WPS database for each profile pair (i,j) to ensure a good response time of the filtering engine. The affinity threshold and the membership criteria make it possible to limit the affinity coefficient number.

Storage of the affinity coefficients also ensures a rapid startup.

It is also necessary to define a process for updating these coefficients in response to the updating of the original data (profiles).

The WPS filtering engine (S3) is a server component that calculates the affinity groups and the associated information for a particular map determined by the user identifier, the name of the map. The filtering engine must bring together all of the information on the profiles to be analyzed: user profiles, recommendation profiles, advertising profiles and the like.

It accesses the affinity coefficients stored in the WPS database and determines from them the affinity group associated with the current user to accomplish this. Then it requests from the WPS data manager the information pertaining to these profiles for transmission to the analyzer (S4).

In all cases, the raw data pertaining to the retained profiles must be projected in memory to ensure the analysis time. The memory consumption of this component, therefore, depends essentially on the size of the affinity group.

The analysis and recommendation engine (S4) is a server component with an essential function. It analyzes the data provided by the component (S3) to define a first placement of the characteristics and the reference object (i.e., the current user). It calculates the information required for the definitive placement of the objects and characteristics as well as the recommendations to transmit them to the map generator.

The memory consumption of this module is one of the important factors in the dimensioning of the servers. The memory used is essentially composed of the description of the analyzed profiles and the ray tracing matrices. This memory is allocated solely during the calculation of a map and freed up its generation.

The map generator (S5) is a server component responsible for the synthesis of the WPS map: It constructs the image in the vectorial direction (positioning in multidimensional space), ensuring the lack of overlap and maximal readability. It selects the graphics (according to the characteristics of the map and the client machine). It calculates and integrates the dynamic and static recommendations (according to the characteristics of the map) and, in particular, the advertising images. It generates a file describing the map both in terms of its graphical appearance (graphical objects) and at the level of its interaction (interactive zones, menus, submenus). The file format can be based on XML.

The map displayer is a client component constructing on the client machine the global image of the map from the vectorial map as well as the interaction zones (contextual menus) from the information transmitted in the file generated by the component (S5).

This module also records the user's actions on the map: selection of a recommendation, click on an advertising zone, access to a trend and the like.

This module is subjected the most to constraints with regard to platforms and types of navigators to support. Implementation in the form of a Java 1 applet appears to be the best alternative to ensure maximal portability.

The recorder of user actions is a server component which receives the information on the user actions transmitted by the display component (S6) and stores it.

The recording of the internauts' actions on the WPS map is the determinant element for measuring the return on the investment in the system. The genericity of a SGBD outing must enable analysis of the data obtained from classic analysis tools. The WPS system configuration manager system is a component constituted by a simple graphical interface designed for the site administrators and allowing configuration of the connections and the data dictionary.

The WPS map configuration manager is a component constituted by a simple graphical interface allowing the site administrators or integrators to configure the maps and their particular characteristics such as, for example:

1) Data
a) Description of the data
b) Methods for accessing the data

2) Form
a) “You are here” image
b) Images and symbols representing the squares
   i) optionally according to the square properties
c) Images and symbols representing the neighborhoods
   i) optionally according to the neighborhood properties
d) Colors of the map

3) Interactivity
a) Definition of menus and submenus of squares
   i) Dynamic definitions (according to the profile)
   ii) Static recommendations (from the WPS site)
b) Definition of the menus and submenus of neighborhoods

The map marketing workshop is a component constituted by a simple graphical interface allowing the site's marketing department to modify the map environment in order to animate the site

Adjustment of marketing targets in relation to traffic

Installation of promotions (suggestions fixed outside of the user profile) by means of the functionalities of targeted recommendations and advertisements. The marketing workshop integrates a data presentation module which exploits the information on the users' behavior in relation to the WPS map. It generates graphics and reports such as, for example, the number of clicks on the WPS map, the distribution of these clicks in relation to the WPS recommendations, etc.

1. A process for generating a dynamic and contextualized cartography of information comprising:
a step of collaborative filtration which includes determining at least one affinity group formed from a set of profiles, wherein the distance from the profile to a reference object is less than a threshold value,
a step of correlation analysis of characteristics of the reference object and objects of the affinity group projecting the characteristics into a multidimensional space, and
a step of construction of an image composed of activatable zones representing the characteristics of the reference object and of all or part of the characteristics of the affinity group, and zones representing links among the characteristics, each zone providing direct or indirect access to one or more digital files.

2. The process according to claim 1, wherein the image further comprises activatable zones representing the objects of the affinity group.

3. The process according to claim 1, further comprising describing the zones representing the characteristics in the form of squares, the zones representing the objects by neighborhoods and the zones representing the links between characteristics by streets.

4. The process according to claim 1, further comprising describing the zones representing the characteristics in the form of departments, the zone representing the objects by aisles, the zones representing the links between characteristics by polygons in the aisles.

5. The process according to claim 1, further comprising calculating implicit characteristics of a user by recording in a memory parameters associated with descriptors of historical actions of said user.

6. The process according to claim 5, wherein the descriptors of the historical actions of said user are constituted of identifiers of pages consulted by said user.

7. The process according to claim 1, further comprising calculating explicit characteristics of a user by recording in a memory parameters defined from a preferences table.

8. The process according to claim 1, wherein the profiles are sets of weighted characteristics.

9. The process according to claim 1, wherein each object oₖ is described by a vector (p_{k,0}, Σ, p_{k,i}, Σ, p_{k,p-1}) in which p_{k,i} is a weighting describing the value of characteristic cᵢ for the object oₖ.

10. The process according to claim 1, further comprising commanding the display, in a zone representing the characteristics, of a menu comprising characteristics or subcharacteristics recommended as a function of profiles determined by an administrator.

11. The process according to claim 1, further comprising commanding the display, in a zone representing the characteristics, of a menu comprising a set of characteristics or subcharacteristics recommended by an affinity group.

12. The process according to claim 11, wherein the administrator can define the content or method defining the content of the menu displayed in a zone representing characteristics or objects.

13. The process according to claim 10, wherein a recommended characteristic is not taken into account for calculation of positioning of the characteristics.

14. The process according to claim 10, wherein a recommended characteristic is taken into account for calculation of positioning of characteristics.

15. The process according to claim 1, wherein the object is a user of a Web site and the characteristics and subcharacteristics are deduced directly or indirectly from the user's actions on the site.
